(19) United States
(12) Patent Application Publication
(10) Pub. No.: US 2004/0226310 A1
(43) Pub. Date: Nov. 18, 2004

(54) Air filtering system and a kit therefor

(76) Inventor: Albrecht Fuchs, Zikhron Yaakov (IL)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/667,592

(22) Filed: Sep. 23, 2003

(30) Foreign Application Priority Data
May 12, 2003 (IL) 155,861

(51) Int. Cl. F25D 17/04; B01D 19/00; B01D 45/00; B01D 46/00; B01D 47/00; B01D 49/00; B01D 50/00; B01D 51/00; B01D 53/00; B01D 57/00; B01D 59/00

(52) U.S. Cl. 62/317; 55/467.1

(57) ABSTRACT

The invention provides a combination of a kit for air filtration and an air-conditioning unit, including an air-conditioning unit of the type installed inside a room, having a front, back, top, bottom and side walls, and a compartment having an air intake port, air outlet aperture and means for engaging with a wall of the air-conditioning unit, so as to form a single body when engaged, the compartment being sized to enclose a power source and an air filter attached at its air inlet to the port for propelling filtered air through said aperture into the air-conditioning unit.

### FIELD OF THE INVENTION

The present invention relates to systems for protection against NBC contamination and more particularly, to a combination of an air-conditioning unit with such a system.

### BACKGROUND OF THE INVENTION

Experience has taught that the need to stay inside a space protected against NBC contamination may stretch over many days and nights during summer and winter periods, when air-conditioning is required.

Up to now, air-conditioning units could not be operated during alert periods in protected spaces against possible NBC attacks, due to the basic requirement of not admitting unfiltered air inside the protected spaces. While it is true that air-conditioning units could be shut off upon receiving an attack alarm, it is clear that in such a situation, one would probably not be sufficiently aware of having to shut off an air-conditioning unit. Moreover, once such a unit is shut off, extended stay inside the space, at least, makes it uncomfortable, not to mention unbearable and even dangerous, especially to infants and the elderly.

### DISCLOSURE OF THE INVENTION

It is therefore a broad object of the present invention to provide a system which safely renders both air-conditioning and filtered air, to a protected space.

It is a further object of the present invention to provide a combination of a kit for air filtration and an air-conditioning unit.

It is still a further object of the present invention to provide a combination of a self-powered air filtering assembly and an air-conditioning unit.

According to the invention, there is provided a combination of a kit for air filtration and an air-conditioning unit, comprising an air-conditioning unit of the type installed inside a room, having a front, back, top, bottom and side walls, and a compartment having an air intake port, air outlet aperture and means for engaging with a wall of said air-conditioning unit, so as to form a single body when engaged; said compartment being sized to enclose a power source and an air filter attached at its air inlet to said port for propelling filtered air through said aperture into said air-conditioning unit.

The invention further provides a combination of an air-conditioning unit and an air filtering assembly, comprising an air conditioning unit of the type installed inside a room, having an air intake aperture; an air filter having an inlet port and an outlet opening, said opening being in fluid communication with said aperture; a power source associated with at least said air conditioning system, and an electronically controlled unit for selectively operating the air-conditioning unit, the circulation of fresh filtered air or the propulsion of both, filtered and conditioned air.

According to a further aspect of the invention there is provided a kit to be associated with an air-conditioning unit, comprising a compartment housing an air filter connectable to a blower for sucking in air from the outside of a protected space, and a power source for operating said air-conditioning unit and blower.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of the combination according to the present invention as assembled and mounted for operation;

FIG. 2 is an enlarged perspective view of the combination of an air-conditioning unit and the kit according to the present invention;

FIG. 3 is a perspective view of the kit according to the present invention, in its disassembled state, and

FIG. 4 is perspective view of the present invention in its partly assembled state.

### DETAILED DESCRIPTION OF PREFERRED EMBODIMENTS

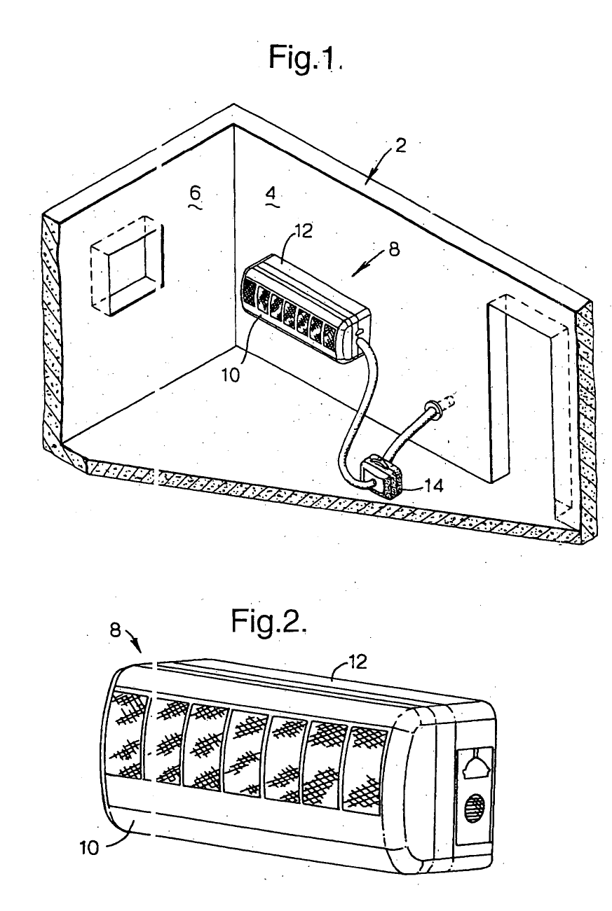

There is illustrated in FIG. 1 a combination of an air-conditioning unit and an air filtering assembly according to the present invention, as mounted on a wall of a room constituting a protected space against NBC contamination, as per-se known. Seen is an enclosure 2, e.g., a room defined by walls 4,6, a combination 8 of an air-conditioning unit 10, e.g., of the type commonly used for air-conditioning inside rooms (as opposed to central air-conditioning systems), and a compartment 12 housing, inter alia, an air filtering assembly, affixed onto the wall 4, advantageously behind the air-conditioning unit 10. There is further seen a blower 14, selectively sucking air from outside the enclosure 2 via, e.g., the wall 4, into the filter (not shown) situated inside the compartment 12.

An embodiment of the air-conditioning unit 10 combined with the compartment 12 housing an air filtering assembly, is illustrated in FIG. 2. According to this embodiment, the compartment 12 is configured to substantially align with the outside dimensions of the unit 10, so as to form an aesthetically pleasing integrated unit which looks like the commonly used room air-conditioner. Naturally, the compartment 12 may be made in any other configuration and affixed to the unit 10 at any other location, not necessarily on the back wall.

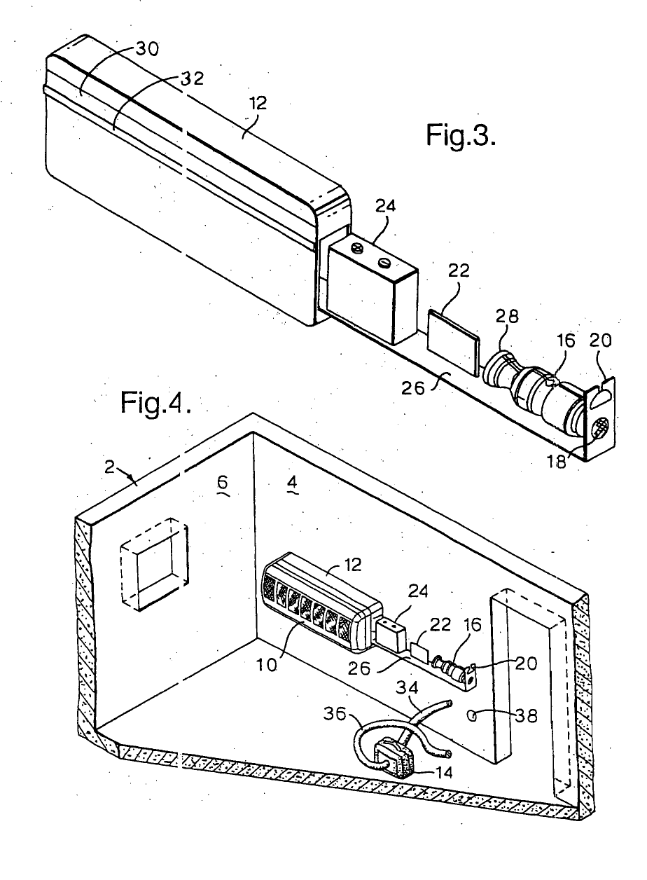

FIG. 3 illustrates the air filtering assembly which may include a filter 16 attached at its inlet to an air intake port 18 made in the lateral wall 20 of the compartment 12, an electronic control unit 22 depicted in the form of an electronic board and a power source 24 in the form of a battery, preferably a rechargeable battery. These three major components are advantageously mounted on a shelf or drawer 26 conveniently slidingly movable into and out of the compartment 12. The filter 16 has an outlet 28 for propelling filtered air through the compartment 12 into the air-conditioning unit 10, via an aperture 30. The compartment 12 is also furnished with means 32, e.g., a flange, facilitating engagement with a unit 10.

Turning now also to FIG. 4, the operation of the system will be described. The combination 8 (FIG. 1) is permanently affixed on a wall inside the protected space and when required, the air-conditioning unit is operated in its regular modes of heating and cooling. When an alert of a possible NBC attack is given, hose 34 of blower 14 is connected to the air intake part 18 and hose 36 is connected to the prepared opening 38 made in the wall 4, as per-se known. The system is now ready to operate in either of the following three modes:

1. Fresh filtered air only, e.g., filtered to exclude particles, acid air, alkaline air, NBC contamination, etc.;

2. Air-conditioning only (heating/cooling/blower), or

3. Combination of both of modes 1 and 2 above, and other sub-modes.

The electronic control unit 22, which may also include a timer can, for example, be adjusted to switch the filtering assembly on and off during certain hours or periods of the day, so as to save energy and provide longer filter life.

An important feature of the combination is the ability to assure continuous operation during power failure. The battery 24 may provide fresh filtered air to the protected space, and if required, heated or cooled to the desired degree, for many hours.

It should be noted that while in the illustrated embodiments, the combination is affixed on a wall of the protected space, if, e.g., the walls of such space are soft, i.e., not rigid, like the walls of a tent, the combination 8 can just as well be hung on a stand. The latter will be practicable in tent-based protected spaces such as mobile battlefield operating rooms or the like.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A combination of a kit for air filtration and an air-conditioning unit, comprising:
an air-conditioning unit of the type installed inside a room, having a front, back, top, bottom and side walls, and
a compartment having an air intake port, air outlet aperture and means for engaging with a wall of said air-conditioning unit, so as to form a single body when engaged;
said compartment being sized to enclose a power source and an air filter attached at its air inlet to said port for propelling filtered air through said aperture into said air-conditioning unit.

2. The combination as claimed in claim 1, wherein said compartment is configured to substantially match the size of one of the walls of said air-conditioning unit.

3. The combination as claimed in claim 1, wherein said compartment is fitted with means for installing the compartment on a wall of a room and engaging said air-conditioning unit.

4. The combination as claimed in claim 1, wherein said compartment is engageable with the aperture facing the back wall of said air-conditioning unit.

5. The combination as claimed in claim 1, wherein said power source and air filter are mounted on a shelf having a side portion and said shelf and side portion are slidingly retrievable from the side of said compartment.

6. The combination as claimed in claim 1, wherein said kit further comprises an electronic control unit for selectively operating said air filter.

7. The combination as claimed in claim 6, wherein said electronic control unit is mounted inside said compartment.

8. The combination as claimed in claim 1, wherein said power source is a battery.

9. The combination as claimed in claim 8, wherein said battery is a rechargeable battery.

10. The combination as claimed in claim 1, wherein said kit further comprising an air blower having a connector for engaging said air intake port and being adapted to suck air from the outside of said room.

11. A combination of an air-conditioning unit and an air filtering assembly, comprising:
an air conditioning unit of the type installed inside a room, having an air intake aperture;
an air filter having an inlet port and an outlet opening, said opening being in fluid communication with said aperture;
a power source associated with at least said air conditioning system, and an electronically controlled unit for selectively operating the air-conditioning unit, the circulation of fresh filtered air or the propulsion of both, filtered and conditioned air.

12. The combination as claimed in claim 11, wherein said power source is a battery.

13. The combination as claimed in claim 12, wherein said battery is a rechargeable battery.

14. The combination as claimed in claim 11, wherein said combination further comprising an air blower having a connector for engaging said air inlet port and being adapted to suck air from the outside of said room.

15. A kit to be associated with an air-conditioning unit, comprising a compartment housing an air filter connectable to a blower for sucking in air from the outside of a protected space, and a power source for operating said air-conditioning unit and blower.
